(19) United States
(12) Patent Application Publication
(10) Pub. No.: US 2026/0125029 A1
(43) Pub. Date: May 7, 2026

(54) AUTONOMOUS DRIVING SENSOR CLEANING DEVICE

(71) Applicants: Hyundai Motor Company, Seoul (KR); Kia Corporation, Seoul (KR)

(72) Inventors: Kyung Hwan KIM, Hwaseong-Si (KR); Nak Kyoung KONG, Hwaseong-Si (KR); Sang Heon WANG, Hwaseong-Si (KR); Denis THEBAULT, Issoire (FR); Andrew LASSAUZET, Issoire (FR)

(73) Assignees: Hyundai Motor Company, Seoul (KR); Kia Corporation, Seoul (KR)

(21) Appl. No.: 19/266,691

(22) Filed: Jul. 11, 2025

(30) Foreign Application Priority Data
Nov. 4, 2024 (KR) 10-2024-0154247

(51) Int. Cl. B60S 1/08; B60S 1/32; B60S 1/52; B60S 1/54

(52) U.S. Cl. CPC B60S 1/0822; B60S 1/32; B60S 1/524; B60S 1/54

(57) ABSTRACT

An autonomous driving sensor cleaning device includes a housing assembly; a bracket disposed inside the housing assembly, connected to at least a portion of the housing assembly, and including a camera seating portion; a sensor assembly mounted in the bracket; a cover disposed apart from the sensor assembly and connected to a portion of the housing assembly; a wiper assembly, wherein at least a portion of the wiper assembly is in contact with the cover; a blower assembly adjacent to the wiper assembly and the sensor assembly and including an outlet disposed adjacent to the cover; and a controller configured to control the wiper assembly and the blower assembly.

### CROSS-REFERENCE TO RELATED APPLICATION

The present application claims priority to Korean Patent Application No. 10-2024-0154247 filed on Nov. 4, 2024, the entire contents of which is incorporated herein for all purposes by this reference.

### BACKGROUND OF THE PRESENT DISCLOSURE

### Field of the Present Disclosure

The present disclosure relates to a sensor cleaning device for an autonomous driving vehicle or a vehicle including advanced driver assistance systems (ADAS), and to a sensor cleaning device that can prevent contamination of an external sensor of a vehicle or effectively remove contamination by utilizing a wiper assembly and a blower assembly.

### Description of Related Art

Sensors used in autonomous driving vehicles and advanced driver assistance systems (ADAS) should always be kept clean to accurately detect and recognize a road condition. When the sensors are contaminated, the driving safety and autonomous driving performance of the vehicles may be greatly affected. For the present reason, a sensor cleaning device plays a very important role.

Conventional sensor cleaning devices have mainly used a method of spraying air compressed through an air compressor onto a sensor surface or a method of removing dust or foreign materials from the sensor surface using a wiper. These methods may remove contamination from the sensor surface to some extent, but the compressed air alone has limitations in removing contaminants mixed with moisture or oil, and the wiper method alone has a problem in that it is difficult to prevent contamination before the sensor is contaminated. Furthermore, the continuous use of the compressed air may result in high energy consumption and maintenance costs for the air compressor.

To overcome these limitations of the related art, research on a new cleaning method combining a blower and a wiper assembly has recently been actively conducted. The present method aims to prevent contamination of the sensor by forming an air curtain by drawing air inside the vehicle through a blower and discharging the air onto a cover. Furthermore, the wiper assembly includes a washer liquid outlet in a wiper blade itself, adding a function of spraying a washer liquid according in a direction in which a wiper moves, effectively removing contaminants attached to the sensor surface. Research is being conducted to maintain cleanliness of sensors and improve the safety and performance of autonomous driving vehicles and ADAS.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a sensor cleaning device that can prevent contamination of a sensor by combining a blower and a wiper assembly and can effectively remove contaminants on a sensor surface by including a washer liquid outlet in a wiper blade to spray a washer liquid in a direction in which a wiper moves.

Objectives of the present disclosure are not limited to the above-described objectives, and other objectives of the present disclosure, which are not described, may be clearly understood to those skilled in the art (hereinafter, referred to as an “ordinary skilled in the art”) in the field of the present disclosure to which the present disclosure pertains from the following description.

An autonomous driving sensor cleaning device for achieving the objectives of the present disclosure includes the following configuration.

In an exemplary embodiment of the present disclosure, the present disclosure provides an autonomous driving sensor cleaning device including a housing assembly; a bracket disposed inside the housing assembly, connected to at least a portion of the housing assembly, and including a camera seating portion; a sensor assembly mounted in the bracket; a cover disposed apart from the sensor assembly and connected to a portion of the housing assembly; a wiper assembly, wherein at least a portion of the wiper assembly is in contact with the cover; a blower assembly adjacent to the wiper assembly and the sensor assembly and including an outlet disposed adjacent to the cover; and a controller configured to control the wiper assembly and the blower assembly.

Furthermore, the housing assembly may include a frame to which the bracket is fixed, an upper cover surrounding an upper end portion of the frame, a lower cover fixed to a lower end portion of the frame, and a face cover disposed to surround the cover.

Furthermore, the sensor assembly may include a Light Detection and Ranging (LiDAR) sensor fixed to an upper surface of the bracket, and a camera sensor inserted into the camera seating portion.

Furthermore, the wiper assembly may include a motor, a motor frame connected to the motor, a screw rotatably mounted on the motor frame, a wiper guide coupled to the screw, a wiper arm connected to the wiper guide, and a wiper blade connected to the wiper arm to be in contact with the cover, and washer liquid outlets may be disposed on both side surfaces of the wiper blade.

Furthermore, the wiper blade may be moved integrally with the wiper guide through the wiper arm and moved in a longitudinal direction of the screw by a rotation of the motor.

Furthermore, the autonomous driving sensor cleaning device may further include a bumper mounted on the motor frame, a guide shaft fixed to the motor frame, a washer hose connected to the wiper blade, and a hose guide configured to guide the washer hose.

Furthermore, the blower assembly may include a blower panel connected to the bracket, a blower connected to the blower panel, and an air duct fluidly connected to an outlet of the blower.

Furthermore, the controller may measure a contamination status of the sensor assembly, and when a measured contamination level of the sensor assembly is greater than or equal to a first set value, the controller may be configured for controlling the motor to move the wiper blade moves to a contamination position.

Furthermore, the controller is configured to receive a current position of the wiper blade from a Hall sensor and compare the current position of the wiper blade with the contamination position, and when the wiper blade is not moved to the contamination position, the controller may be configured for controlling the motor to move the wiper blade to the contamination position.

Furthermore, the controller is configured to receive the current position of the wiper blade from the Hall sensor and compares the current position of the wiper blade with the contamination position, and when the wiper blade is moved to the contamination position, the controller may be configured for controlling the motor to move the wiper blade in a reverse direction thereof.

Furthermore, after the controller controls the motor to move the wiper blade in the reverse direction, the controller may re-measure the contamination status of the sensor assembly, and when the sensor contamination level is greater than or equal to a second set value, the controller may be configured for controlling the motor to move the wiper blade to the contamination position.

Furthermore, after the controller controls the motor to move the wiper blade in the reverse direction, the controller may re-measure the contamination status of the sensor assembly, and when the sensor contamination level is less than the second set value, the controller may be configured for controlling the motor to move the wiper blade to a set position.

Furthermore, the controller may measure the contamination status of the sensor assembly, and when the measured sensor contamination level is less than a first set value, the controller may apply the power to the blower.

Furthermore, after the controller supplies the power to the blower, the controller is configured to determine an operating status of the wiper assembly, and when the wiper assembly is operating, the controller may stop a supply of the power to the blower.

Furthermore, after the controller stops the supply of the power to the blower, the controller may re-determine the operating status of the wiper assembly, and when the wiper assembly is not operating, the controller may apply the power to the blower again.

Furthermore, a fluid may be sprayed through the washer liquid outlet in a direction in which the wiper blade is moved.

Other aspects and exemplary embodiments of the present disclosure are discussed infra.

It is understood that the term “vehicle” or “vehicular” or other similar term as used herein is inclusive of motor vehicles in general such as passenger vehicles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

The above and other features of the present disclosure are discussed infra.

### BRIEF DESCRIPTION OF THE DRAWINGS

FIG. 1 is a perspective view exemplarily illustrating an autonomous driving sensor cleaning device as an exemplary embodiment of the present disclosure;

FIG. 2 is an exploded view exemplarily illustrating the autonomous driving sensor cleaning device as an exemplary embodiment of the present disclosure;

FIG. 3 is a diagram illustrating a state in which a sensor assembly, a wiper assembly, and a cover are coupled to a bracket as an exemplary embodiment of the present disclosure;

FIG. 4 is a side cross-sectional view exemplarily illustrating a portion of the autonomous driving sensor cleaning device as an exemplary embodiment of the present disclosure;

FIG. 5A is an exploded view exemplarily illustrating the wiper assembly and a blower assembly as an exemplary embodiment of the present disclosure; and

FIG. 5B is a diagram illustrating an air flow through a blower as an exemplary embodiment of the present disclosure.

It should be understood that the appended drawings are not necessarily to scale, presenting a somewhat simplified representation of various preferred features illustrative of the basic principles of the present disclosure. The specific design features of the present disclosure as included herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in more detail with reference to the accompanying drawings. The exemplary embodiments of the present disclosure may be modified in various forms, and the scope of the present disclosure should not be construed as being limited to the following embodiments. These embodiments are provided to more fully describe the present disclosure to those skilled in the art.

Furthermore, the term “˜part,” “˜unit,” or the like used herein means a unit of processing at least two functions or operations, and the present unit may be implemented by hardware, software, or a combination of hardware and software.

Furthermore, the terms used herein are for describing only specific embodiments and are not intended to limit the present disclosure. Unless the context clearly dictates otherwise, the singular form includes the plural form.

Furthermore, throughout the present specification, when a part is referred to as “comprising” a component, it means that other components can be further included, not excluding the other components unless specifically stated otherwise, and furthermore, terms such as controller 500 and the like described herein mean a unit that processes at least two functions or operations.

Furthermore, a controller 500 may be implemented as a memory, which stores an algorithm for controlling operations of various components disposed in the vehicle or data on a program reproducing the algorithm, and a processor for performing the above-described operations using the data stored in the memory. In the instant case, the memory and the processor may be implemented as separate chips. Alternatively, the memory and the processor may be implemented as a single chip. For example, the controller 500 may include at least two among an electronic control unit (ECU), a central processing unit (CPU), a microprocessor unit (MPU), a micro controller unit (MCU), an application processor (AP), and any type of processor well known in the art.

Furthermore, the controller 500 may be formed of a combination of software and hardware which are configured for performing an operation on at least two applications or programs for executing methods according to the exemplary embodiments of the present disclosure.

Furthermore, in the following specification, a front side refers in a direction in which a camera lens faces based on a position where an autonomous driving sensor device is fixed to a vehicle body. Moreover, an upper end portion means an upward position based on a position where a sensor device is fixed to the vehicle body, and a lower end portion means a downward position based on the base position.

Furthermore, in the following specification, since a contamination level of the sensor is determined based on contamination of a surface of a cover 102, the wiper assembly 300 and a blower assembly 400 remove contaminants from the surface of the cover 102 and prevent contamination.

Hereinafter, various exemplary embodiments will be described in detail with reference to the accompanying drawings, and in describing with reference to the accompanying drawings, the same or corresponding components are assigned the same reference numerals, and duplicate descriptions thereof will be omitted therein.

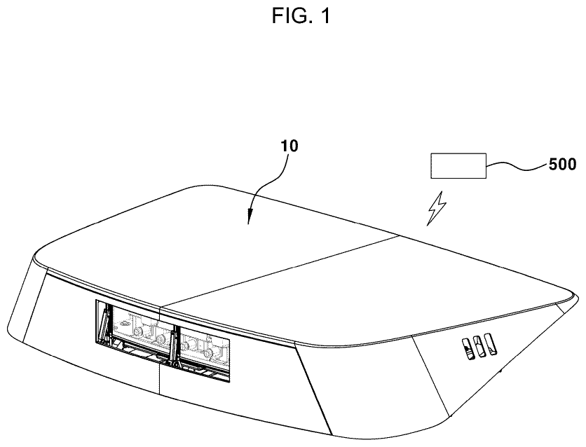

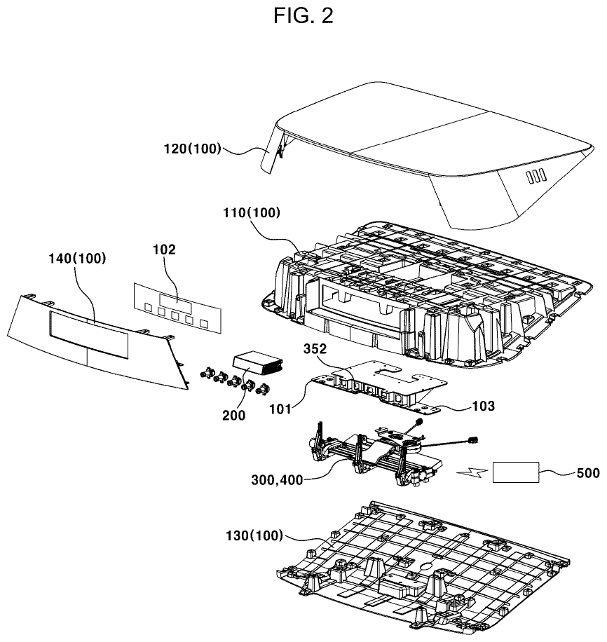

FIG. 1 is a perspective view exemplarily illustrating an autonomous driving sensor cleaning device 10, and FIG. 2 is an exploded view exemplarily illustrating the autonomous driving sensor cleaning device 10 as an exemplary embodiment of the present disclosure.

As an exemplary embodiment of the present disclosure, the autonomous driving sensor cleaning device 10 includes a housing assembly 100 for protecting internal components from an external environment, a sensor assembly 200 for collecting environmental information while driving, and a wiper assembly 300 and a blower assembly 400 which remove contaminants from the surface of the cover 102.

Furthermore, the autonomous driving sensor cleaning device 10 includes the cover 102 for protecting the sensor assembly 200 from contamination, a bracket 101 for supporting the sensor assembly 200, the wiper assembly 300, and the blower assembly 400, and a controller 500 for controlling the wiper assembly 300 and the blower assembly 400.

The housing assembly 100 is configured to protect the internal components of the autonomous driving sensor cleaning device 10. The housing assembly 100 includes a frame 110, an upper cover 120, a lower cover 130, and a face cover 140.

The frame 110 is a support of the housing assembly 100, fixes the bracket 101, and provides a structure to which other components are coupled. The frame 110 fixes the sensor assembly 200 and wiper assembly 300 and may be made of a durable material such as an aluminum alloy or a high-strength plastic material to protect the above components.

Furthermore, the upper cover 120 is coupled to an upper end portion of the frame 110 to surround an upper portion of the frame 110, and the lower cover 130 is coupled to a lower portion of the frame 110 to surround a lower portion of the frame 110, and thus the frame 110 may be sealed by the upper cover 120 and the lower cover 130.

The upper cover 120 surrounding an upper surface of the frame 110 may be formed of a flat upper surface and curved side surfaces. When the autonomous driving sensor cleaning device 10 is coupled to the vehicle body, one end portion of the upper surface of the upper cover 120 may be disposed at a position which is relatively higher than that of the other end portion based on the vehicle body, and the other end portion of the upper cover 120 may be disposed at a position which is a relatively lower than that of the one end portion. Moreover, both side surfaces of the upper cover 120 are each formed in a curved shape so that air resistance may be minimized.

Furthermore, one end portion of the lower cover 130 disposed at a lower end portion of the frame 110 is connected to the other end portion of the upper surface of the upper cover 120, and both end portions of the lower cover 130 are connected to lower portions of both the side surfaces of the upper cover 120 thereby sealing the frame 110 together with the upper cover 120.

The cover 102 is seated on a fixing portion formed at one end portion of the frame 110, faces the sensor assembly 200, and is connected to the frame 110 while maintaining a constant gap therebetween. Furthermore, to secure a clear view of the sensor assembly 200, the cover 102 may be manufactured of a material with transparency which is higher than or equal to set transparency and durability which is higher than equal to predetermined durability to correspond to a driving environment of the vehicle. As an exemplary embodiment of the present disclosure, the cover 102 may be made of a material such as polycarbonate, acrylic, or a tempered glass, and the surface of the cover 102 may be treated with a water-repellent coating or a fluorine coating to prevent contaminants from easily attaching to the surface.

Furthermore, the face cover 140 is disposed to surround the frame 110 and the cover 102 between the upper cover 120 and the lower cover 130. The face cover 140 is configured as an external protection for the device, may have one surface formed as a curved or flat surface according to the design of the vehicle to harmonize with the design of the vehicle, and may include an opening in the center.

The bracket 101 is connected to an internal upper end portion of the frame 110 and supports the sensor assembly 200 and the blower assembly 400. The bracket 101 may be connected to the sensor assembly 200 through various fastening devices and may be connected to the blower assembly 400 through a fastening plate 103 disposed parallel to an upper surface of the bracket 101 and disposed below the bracket 101.

Furthermore, a Light Detection and Ranging (LiDAR) sensor 210 may be fixed to the upper surface of the bracket 101 through a bolt or screw fastening, and a camera sensor 220 may be inserted into a camera seating portion of the bracket 101 and fixed thereto.

The LiDAR sensor 210 is fixed to the upper surface of the bracket 101 through a bolt or screw fastening method, and a position of the sensor may be adjusted through a slot-shaped hole or a screw thread hole formed in the bracket 101.

The camera sensor 220 is inserted into and fixed to the camera seating portion formed in the bracket 101 and disposed to face the front side of the autonomous driving sensor cleaning device. Moreover, a camera lens of the camera sensor 220 is fixed in a form of protruding from the seating portion and may detect and record a front environment in real time while driving.

Furthermore, the wiper assembly 300 is configured to remove contamination occurring on the cover 102. To the present end, the wiper assembly 300 may include a motor 310, a motor frame 320, a screw 330, a wiper guide 340, a wiper arm 350, and a wiper blade 360.

First, the wiper blade 360 comes into surface-contact with the cover 102 and removes contaminants such as dust or water droplets attached to the surface of the cover 102. Furthermore, the wiper blade 360 is supported by the wiper arm 350 and moved integrally with the wiper arm 350. Furthermore, one end portion of the wiper arm 350 is connected to the wiper blade 360, and the other end portion of the wiper arm 350 is connected to the wiper guide 340. That is, the wiper blade 360 is integrally moved according to a movement of the wiper guide 340.

Furthermore, the motor 310 is connected to the screw 330, and the screw 330 is connected to the wiper guide 340. Furthermore, when contamination of the cover 102 is measured to be greater than or equal to a setting value, the motor 310 may apply a driving force to the screw 330 to move the wiper guide 340 in a longitudinal direction and remove the contamination through the wiper blade 360 disposed in contact with the cover 102.

Furthermore, washer liquid outlets 352 may be disposed on both side surfaces of the wiper blade 360 and disposed at regular intervals in a longitudinal direction of the wiper blade 360. Furthermore, the washer liquid outlet 352 is fluidly connected to a washer tank through a washer hose 351. Accordingly, a washer liquid may be pressurized by a washer liquid pump disposed adjacent to the washer tank and discharged from the washer tank to the washer liquid outlet 352 by flowing through the washer hose.

The blower assembly 400 is connected to the bracket 101 and disposed inside the frame 110, and when the wiper assembly 300 does not operate, the blower assembly 400 operates by receiving power from the controller 500. When the power is supplied from the controller 500 connected to a power source to the blower assembly 400, the blower assembly 400 is controlled to allow the air inside the frame 110 to flow through an air duct 430 to be discharged to the cover 102.

Furthermore, the blower assembly 400 includes a blower panel 410 connected to the bracket 101 and configured to fix the blower assembly 400, a blower 420 configured to draw air inside the frame 110, and the air duct 430 in which the drawn air flows.

The blower assembly 400 continuously forms an air curtain along an external surface of the cover 102 by drawing the air inside the frame 110 and discharging the air to the cover 102. Here, the air curtain refers to an air barrier used to separate two spaces or to distinguish the outside from the inside by forming a high-speed air flow.

Furthermore, the controller 500 receives a contamination status information from the contamination detection sensor and is configured to control the wiper assembly 300 to remove contaminants in response to the contamination status. When the wiper assembly 300 operates, the controller 500 checks a position of the wiper blade 360 in real time through a Hall sensor, and as necessary, additionally controls the motor 310 to move the wiper blade 360 to a contamination position. A rain sensor may also be used as a contamination detection sensor, and a perception sensor such as a camera or LiDAR may similarly function as a contamination detection sensor.

Furthermore, when the controller 500 determines that the contamination is removed, the controller 500 terminates the operation of the wiper assembly 300, and when the operation of the wiper assembly 300 is terminated, the controller 500 is configured to perform a mechanism for controlling the blower assembly 400 to allow the air of the frame 110 to be discharged to the cover 102.

In the present way, the autonomous driving sensor cleaning device 10 operates by mutually combining and interlocking the housing assembly 100, the bracket 101, the sensor assembly 200, the cover 102, the wiper assembly 300, the blower assembly 400, and the controller 500.

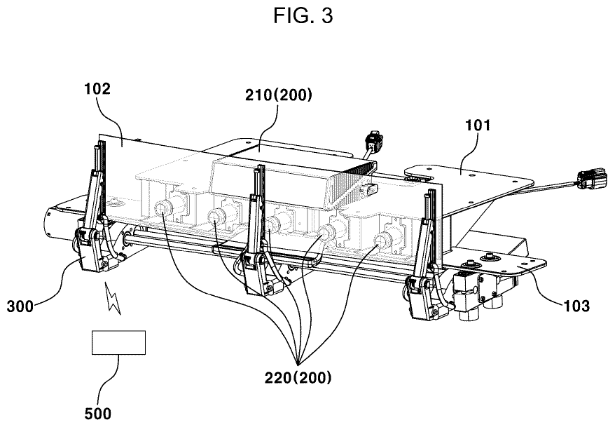

FIG. 3 shows a state in which the sensor assembly 200, the wiper assembly 300, and the cover 102 are coupled to the bracket 101.

As an exemplary embodiment of the present disclosure, the LiDAR sensor 210 and the camera sensor 220 are components for collecting environmental information while the autonomous driving vehicle is traveling and may be disposed at different heights in the bracket 101.

The LiDAR sensor 210 is fixed to the center portion of the upper surface of the bracket 101 and disposed at a position which is relatively higher than that of the camera sensor 220 based on the vehicle body. In the present way, the LiDAR sensor 210 secures a field of view capable of collecting a wide range of three-dimensional spatial information.

Furthermore, the camera sensor 220 may be fixed to the camera seating portion to face the front side of the autonomous driving sensor cleaning device through a screw-type fixing portion or a clip-type connecting portion. In the instant case, the camera sensor 220 may be disposed at a position which is relatively lower than that of the LiDAR sensor 210 based on the vehicle body.

The wiper guide 340 may be disposed at a position which is lower than that of the camera sensor 220 at the lower end portion of the bracket 101 based on the vehicle body and disposed perpendicular to the wiper blade 360 disposed in surface-contact with the cover 102.

Furthermore, the controller 500 detects the contamination status of the sensor surface in real time from the contamination detection sensor mounted in the sensor assembly 200 and is configured to control the motor 310 to move the wiper blade 360 in a longitudinal direction of the screw 330 to remove the contaminants.

The controller 500 is configured to determine the contamination status of the sensor surface received from the contamination detection sensor, and when a contamination level of the sensor exceeds a first setting value stored in controller 500, the controller 500 applies power to the motor 310.

Here, the first setting value means a reference value for determining the contamination status of the sensor surface, and in the following specification, a second setting value means a reference value for determining removal of contaminants. The second setting value may be set to a value indicating a lower contamination level than the first setting value.

Furthermore, the controller 500 rotates the motor 310 to move the wiper blade 360 to the contamination position, and the wiper blade 360 is moved along the surface of the cover 102 in the longitudinal direction of the screw 330.

Furthermore, while the wiper blade 360 is moved to the contamination position, the controller 500 receives the position information of the wiper blade 360 in real time through the Hall sensor and is configured to determine whether the wiper blade 360 reaches the contamination position. The contamination position refers to a specific area on the cover 102, centered on the contamination detected by the sensor, with a set margin.

The controller 500 is configured to determine whether the wiper blade 360 reaches the contamination position. When the wiper blade 360 does not reach the contamination position, the controller 500 is configured to control the motor 310 to move the wiper blade 360 to the contamination position. In the instant case, the motor 310 rotates the screw 330 in a direction in which the wiper blade 360 approaches the contamination position.

On the other hand, when the wiper blade 360 reaches the contamination position, the controller 500 is configured to control the motor 310 to move the wiper blade 360 in a direction away from the contamination position.

Moreover, when the wiper blade 360 is moved in the direction away from the contamination position, the controller 500 re-measures the contamination status of the surface of the cover 102 through the contamination detection sensor. In the instant case, when a contamination level of the sensor is greater than or equal to the second setting value set in the controller 500, the controller 500 is configured to control the motor 310 to move the wiper blade 360 to the contamination position again.

Otherwise, when the contamination level of the sensor is less than the second setting stored in the controller 500, the controller 500 is configured to determine that the removal of the contaminant is completed. In the instant case, the controller 500 returns the wiper blade 360 to an initial position and terminates the operation of the wiper assembly 300.

Such a series of processes controls each component of the autonomous driving sensor cleaning device 10 gradationally to effectively manage the surface of the cover 102, enabling the sensor assembly 200 to accurately recognize the external environment.

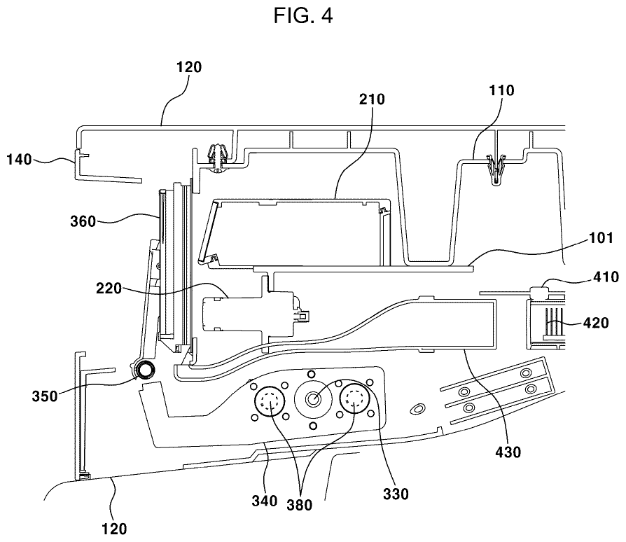

FIG. 4 shows a portion of a side cross-sectional view of the autonomous driving sensor cleaning device 10.

As an exemplary embodiment of the present disclosure, the blower assembly 400 is disposed between the bracket 101 and the wiper guide 340.

Furthermore, among the components of the blower assembly 400, the air duct 430 is disposed above the wiper guide 340, and an upper surface of the air duct 430 may be manufactured in a streamlined shape from an inlet to an outlet. Furthermore, the air duct 430 may be formed in a shape in which a cross-sectional area is gradually decreased from the inlet to the outlet.

Furthermore, the outlet of the air duct 430 may be disposed to include a predetermined angle of 60° to 90° with respect to the cover 102 based on a height direction of the vehicle. The outlet of the air duct 430 may be disposed perpendicular to the cover 102 (90°) or may be disposed to face the cover 102 at an angle within the present range. The outlet of the air duct 430 may be disposed perpendicular to the cover 102 or may be disposed to face the cover 102. In the present way, the air drawn into the air duct 430 through the blower 420 is discharged from the air duct 430 to be sprayed toward the cover 102.

Furthermore, the blower 420 fluidly connected to the air duct 430 is disposed adjacent to the inlet of the air duct 430 and may be connected to the blower panel 410, which is connected to a bottom surface of the bracket 101, through a bolt or screw fastening. In the present way, the air duct 430 may be fixed to the frame 110.

Furthermore, one end portion of the LiDAR sensor 210 disposed adjacent to an internal upper end portion of the frame 110 may be manufactured to include a predetermined angle with respect to the cover 102 based on the height direction of the vehicle. The camera lens of the camera sensor 220 inserted into the seating portion of the frame 110 is fixed to the bracket 101 in a protruding form and may be disposed to face the cover 102.

Furthermore, as shown in the drawing, the components of the autonomous driving sensor cleaning device 10 are surrounded by the upper cover 120, the lower cover 130, and the face cover 140.

Furthermore, the upper cover 120 surrounds the upper portion of the frame 110, and the lower cover 130 surrounds the lower portion of the frame 110. The face cover 140 includes a structure for surrounding one surface of the cover 102 so that the cover 102 may be protected and the components such as the bracket 101 and the camera lens may be safely protected from the outside thereof. Furthermore, a protrusion extending toward the cover 102 may be included in the upper end portion of the face cover 140.

In the present way, in the autonomous driving sensor cleaning device 10, the housing assembly 100, the frame 110, the blower assembly 400, the wiper assembly 300, and the cover 102 are mutually combined and disposed.

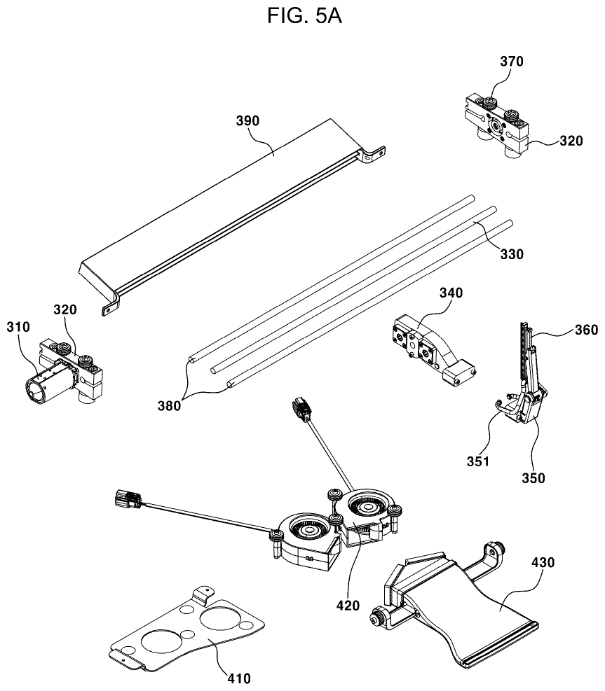

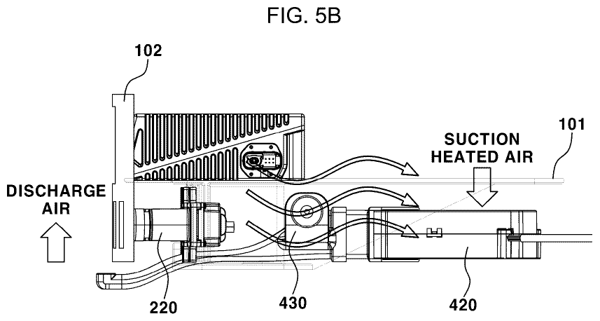

FIG. 5A shows an exploded view of the wiper assembly 300 and the blower assembly 400 as an exemplary embodiment of the present disclosure.

As an exemplary embodiment of the present disclosure, the wiper assembly 300 includes the wiper blade 360, the wiper arm 350, and the wiper guide 340. The wiper assembly 300 further includes the screw 330 connected to the wiper guide 340, the motor 310 configured to rotate the screw 330 to move the wiper guide 340, and the motor frame 320 to which the motor 310 and the screw 330 are fixed.

Furthermore, the wiper assembly 300 includes a bumper 370 configured to absorb a vibration due to a rotation of the motor 310, a guide shaft 380 configured to guide a movement of the wiper guide 340, the washer liquid outlets 352, the washer hose 351 connected to the wiper arm 350 and configured to supply a washer liquid through the washer liquid outlets 352 formed on the wiper blade 360, and a hose guide 390 configured to prevent twisting of the washer hose 351.

The motor 310 is disposed on one side surface of the motor frame 320 and is fixed by the motor frame 320. The motor 310 may be connected to the screw 330 through a coupling fastening method, a belt and pulley fastening method, or a gear and chain fastening method. Moreover, the motor 310 rotates in a forward or reverse direction to rotate the screw 330, and the wiper guide 340 is moved in the longitudinal direction of the screw 330 according to a rotation of the screw 330. Here, the forward direction refers to a direction of the rotation of the screw 330 in which the wiper blade 360 is moved to be close to the contamination position, and the reverse direction refers to a direction of the rotation of the screw 330 in which the wiper blade 360 is moved away from the contamination position.

Furthermore, the screw 330 is rotated by the motor 310 and may be disposed between the motor frames 320 disposed on left and right side surfaces of the autonomous driving sensor cleaning device 10. Furthermore, the screw 330 may be formed as an endless screw 330. The endless screw 330 refers to a screw 330 with both end portions not closed and with spiral grooves that continue endlessly. The present design allows continuous operation without interruption, reducing wear and improving efficiency.

Furthermore, the wiper guide 340 is provided with a lead nut including a screw thread formed therein, and the lead nut may be coupled to an external screw thread of the screw 330 to be connected to the screw 330. In the present way, the wiper guide 340 is connected to the screw 330 and moved to left and right in the longitudinal direction of the screw 330 according to the rotation of the motor 310 in the forward or reverse direction thereof.

Furthermore, as the wiper guide 340 is moved, the wiper blade 360, which is connected to the wiper guide 340 through the wiper arm 350, may be moved to left and right in the longitudinal direction of the screw 330 as integrated with the wiper guide 340.

The wiper arm 350 may provide a predetermined pressure through a spring mounted therein to allow the wiper blade 360 to be in surface-contact with an external surface of the cover 102. Through the present mechanism, the wiper blade 360 maintains a constant pressure along the external surface of the cover 102 even when moving along a curved or irregular surface of the cover 102.

The washer hose 351 may be connected to each of both sides of the wiper blade 360. The washer hose 351 is fluidly connected to a washer tank and becomes a passage through which the washer liquid flows from the washer tank.

The hose guide 390 is connected to one end portions of the two motor frames 320, includes an upper portion of a flat surface, and is configured to guide a movement of the washer hose 351 not interfered with when the wiper blade 360 is moved along the screw 330.

Since the wiper blade 360 moves only in a lateral direction, the hose guide 390 is structured to restrict movement in the H and T directions while allowing movement only along the L direction. Furthermore, the hose guide 390 is separated into two parts, allowing the washer hose to move in the L direction independently within each guide, thereby preventing twisting or entanglement of the hoses.

Moreover, the guide shaft 380 may be disposed parallel to the screw 330 and may guide a movement of the wiper guide 340 in the longitudinal direction of the guide shaft 380. At least two or more guide shafts 380 may be included, and when two or more guide shafts 380 are provided, the screw 330 may be disposed between the two guide shafts 380.

The bumper 370 is mounted on each motor frame 320 in a direction perpendicular to the motor 310 and is configured to perform absorbing an impact when the wiper guide 340 reaches both end portions of the screw 330, preventing the wiper assembly 300 from being damaged.

FIG. 5B is a diagram illustrating an air flow through the blower assembly 400.

As an exemplary embodiment of the present disclosure, the blower 420 draws air inside the bracket 101, introduces the drawn air into the air duct 430, and discharges the drawn air into the cover 102 through the outlet of the air duct 430.

Moreover, a temperature of the air inside the bracket 101 may increase due to driving heat generated due to the operation of the LiDAR sensor 210 and the camera sensor 220. The blower 420 draws the air whose temperature increases to cool the surroundings of the LiDAR sensor 210 and the camera sensor 220, introduces the air whose temperature increases into the air duct 430, and sprays the air along the external surface of the cover 102 through the outlet of the air duct 430.

That is, the air inside the bracket 101, which is introduced through the blower 420, flows along the air duct 430 and is discharged to the cover 102 to form an air curtain in the cover 102.

According to the present mechanism, the controller 500 measures a contamination status of the sensor assembly 200 first, and when the measured sensor contamination level is less than a first set value stored in the controller 500, the controller 500 supplies power to the blower 420 to allow the air to be discharged to the cover 102.

Furthermore, the controller 500 supplies the power to the blower 420 and then continuously determines an operating status of the wiper assembly 300. In the instant case, when the controller 500 determines that the wiper assembly 300 is operating, the controller 500 applies an OFF signal to the blower assembly 400 to stop the operation of the blower assembly 400. This is to prevent interference between the wiper assembly 300 and the blower assembly 400.

Furthermore, after the controller 500 stops the supply of the power to the blower assembly 400, the controller 500 re-evaluates the operating status of the wiper assembly 300, and when a supply of the power to the wiper assembly 300 is stopped, the controller 500 is configured to determine that the operating status of the wiper assembly 300 is an OFF state.

In the instant case, when the operation status of the wiper assembly 300 is the OFF state, the controller 500 supplies power to the blower 420 to operate the blower assembly 400.

Through these processes, the controller 500 prevents interference between the operations of the wiper assembly 300 and the blower 420 and constantly operates the blower 420 to prevent foreign materials from being accumulated on the cover 102.

In summary, the present disclosure relates to an autonomous driving sensor cleaning device 10, and the autonomous driving sensor cleaning device 10 is configured to determine the level of contamination of a sensor, and when it is determined that a physical removal of contaminants is necessary, the autonomous driving sensor cleaning device 10 operates the wiper assembly 300 to remove the contaminants. Furthermore, the present disclosure has a technical feature of constantly operating the blower assembly 400 even when the wiper assembly 300 is not operating to form an air curtain in the cover 102, preventing contamination of the cover 102 in advance.

The present disclosure can obtain the following effects according to a combination of the above-described embodiments and a configuration, which will be described below, and a use relationship.

First, according to an exemplary embodiment of the present disclosure, an air curtain is formed through a blower assembly so that contamination of a sensor surface may be prevented. In the present way, reliability and safety of an autonomous driving system may be improved.

Second, a wiper assembly 300 of the present disclosure can effectively remove contaminants from the sensor surface by spraying a washer liquid. In the present way, a clean state of the sensor may be maintained and performance of the sensor may be maximized.

Third, a controller of the present disclosure can monitor a contamination status of the sensor in real time and automatically perform a cleaning operation. In the present way, safety and efficiency of an autonomous driving vehicle may be improved.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An autonomous driving sensor cleaning apparatus, comprising:
a housing assembly;
a bracket disposed inside the housing assembly, connected to at least a portion of the housing assembly, and including a camera seating portion;
a sensor assembly mounted in the bracket;
a cover disposed apart from the sensor assembly and connected to a portion of the housing assembly;
a wiper assembly, wherein at least a portion of the wiper assembly is in contact with the cover;
a blower assembly adjacent to the wiper assembly and the sensor assembly and including an outlet disposed adjacent to the cover; and
a controller configured to control the wiper assembly and the blower assembly.

2. The autonomous driving sensor cleaning apparatus of claim 1, wherein the housing assembly includes:
a frame to which the bracket is fixed;
an upper cover surrounding an upper end portion of the frame;
a lower cover fixed to a lower end portion of the frame; and
a face cover disposed to surround the cover.

3. The autonomous driving sensor cleaning apparatus of claim 1, wherein the sensor assembly includes:
a Light Detection and Ranging (LiDAR) sensor fixed to an upper surface of the bracket; and
a camera sensor inserted into the camera seating portion.

4. The autonomous driving sensor cleaning apparatus of claim 1,
wherein the wiper assembly includes:
a motor;
a motor frame connected to the motor;
a screw connected to the motor and rotatably mounted on the motor frame;
a wiper guide coupled to the screw;
a wiper blade contacting with the cover and including washer liquid outlets disposed on at least one of first and second side surfaces of the wiper blade; and
a wiper arm pivotally connecting the wiper blade to the wiper guide.

5. The autonomous driving sensor cleaning apparatus of claim 4, wherein the wiper blade and the wiper guide are elastically coupled.

6. The autonomous driving sensor cleaning apparatus of claim 4, wherein the wiper blade is moved integrally with the wiper guide through the wiper arm and moved in a longitudinal direction of the screw by a rotation of the motor.

7. The autonomous driving sensor cleaning apparatus of claim 4, further comprising:
a guide shaft fixed to the motor frame and slidably coupled to the wiper guide.

8. The autonomous driving sensor cleaning apparatus of claim 4, further comprising:
a bumper mounted on the motor frame;
a washer hose connected to the wiper blade; and
a hose guide configured to guide the washer hose.

9. The autonomous driving sensor cleaning apparatus of claim 1, wherein the blower assembly includes:
a blower panel connected to the bracket;
a blower connected to the blower panel; and
an air duct fluidly connecting the outlet of the blower assembly to an outlet of the blower, wherein an end of the air duct is faced to the cover.

10. The autonomous driving sensor cleaning apparatus of claim 1, wherein the controller is configured to operate either a blower of the blower assembly or a motor of the wiper assembly according to a contamination status of the sensor assembly.

11. The autonomous driving sensor cleaning apparatus of claim 4, wherein the controller is further configured for measuring a contamination status of the sensor assembly, and based on that a measured contamination level of the sensor assembly is greater than or equal to a first set value, the controller is further configured to control the motor to move the wiper blade to a contamination position.

12. The autonomous driving sensor cleaning apparatus of claim 11, wherein the controller is further configured to receive a current position of the wiper blade from a Hall sensor and to compare the current position of the wiper blade with the contamination position, and based on that the wiper blade is not moved to the contamination position, the controller is further configured to control the motor to move the wiper blade to the contamination position.

13. The autonomous driving sensor cleaning apparatus of claim 11, wherein the controller is further configured to receive a current position of the wiper blade from a Hall sensor and to compare the current position of the wiper blade with the contamination position, and based on that the wiper blade is moved to the contamination position, the controller is further configured to control the motor to move the wiper blade in a reverse direction thereof.

14. The autonomous driving sensor cleaning apparatus of claim 13, wherein, after the controller controls the motor to move the wiper blade in the reverse direction, the controller re-measures the contamination status of the sensor assembly, and based on that the sensor contamination level is greater than or equal to a second set value, the controller is further configured to control the motor to move the wiper blade to the contamination position.

15. The autonomous driving sensor cleaning apparatus of claim 14, wherein, after the controller controls the motor to move the wiper blade in the reverse direction, the controller re-measures the contamination status of the sensor assembly, and based on that the sensor contamination level is less than the second set value, the controller is configured to control the motor to move the wiper blade to a set position.

16. The autonomous driving sensor cleaning apparatus of claim 15, wherein the controller is further configured for measuring the contamination status of the sensor assembly, and based on that a measured sensor contamination level is less than the first set value, the controller is further configured to apply power to a blower of the blower assembly.

17. The autonomous driving sensor cleaning apparatus of claim 16, wherein, after the controller supplies the power to the blower, the controller is configured to determine an operating status of the wiper assembly, and based on that the wiper assembly is operating, the controller is configured to stop a supply of the power to the blower.

18. The autonomous driving sensor cleaning apparatus of claim 17, wherein, after the controller stops the supply of the power to the blower, the controller is configured to re-measure the operating status of the wiper assembly, and based on that the wiper assembly is not operating, the controller is configured to apply the power to the blower again.

19. The autonomous driving sensor cleaning apparatus of claim 4, wherein a fluid is sprayed through the washer liquid outlets in a direction in which the wiper blade is moved.

20. A vehicle comprising the autonomous driving sensor cleaning apparatus of claim 1.
